(19) United States
(12) Patent Application Publication
(10) Pub. No.: US 2023/0120915 A1
(43) Pub. Date: Apr. 20, 2023

(54) SECURITY INTELLIGENCE PLATFORM ARCHITECTURE AND FUNCTIONALITY

(71) Applicant: LogRhythm Inc., Boulder, CO (US)

(72) Inventors: Sean SCOTT, Castle Rock, CO (US); Jeff HUBBACH, Castle Rock, CO (US)

(21) Appl. No.: 17/929,570

(22) Filed: Sep. 2, 2022

Related U.S. Application Data
(60) Provisional application No. 63/269,689, filed on Mar. 21, 2022.
(60) Provisional application No. 63/262,596, filed on Oct. 15, 2021.

(51) Int. Cl. H04L 9/40

(52) U.S. Cl. CPC H04L 63/1416; H04L 63/1433; H04L 63/20

(57) ABSTRACT

A network monitoring system (100) implements a variety of shared services that aggregate knowledge acquired in connection with multiple client networks and securely leverage such knowledge in monitoring networks of individual clients or entities. The system (100) generally includes a client network (110), a security intelligence platform (SIP) (120), a shared services utility (130), and a browser platform (140) running an application (142). The client network (110) provides a data signal (150), for example, a stream of logs and other structured or unstructured data to the SIP (120) which monitors the client network (110) based on the signal (150) and provides dashboard network information, generates alarms, and provides reports and other processed data as outputs. Such monitoring leverages various shared services of platform (130) including curated content (136) that is sourced from client networks and verified by the system (100).

### CROSS-REFERENCE TO RELATED APPLICATIONS

This application claims benefit of provisional to U.S. Provisional Application No. 63/262,596, filed on Oct. 15, 2021, entitled “SECURITY INTELLIGENCE PLATFORM ARCHITECTURE AND FUNCTIONALITY”, and U.S. Provisional Application No. 63/269,689, filed on Mar. 21, 2022, entitled “SECURITY INTELLIGENCE PLATFORM ARCHITECTURE AND FUNCTIONALITY”. The entire contents of the aforementioned application are hereby incorporated within by reference as if set forth in full.

### FIELD OF THE INVENTION

The present invention relates in general to network monitoring and information management for identifying threats and other types of events of interest with respect to monitored networks. In particular, the invention relates to a monitoring system implementing a platform architecture and associated functionality that enables the system to aggregate knowledge acquired in connection with multiple networks, improve network monitoring including threat detection, and simplify system updates and maintenance.

### BACKGROUND OF THE INVENTION

Modern organizational infrastructures (e.g., made up of routers, switches, file servers, software, and the like) are constantly generating a large volume of data (e.g., log messages, machine-readable data, etc.) that is typically analyzed by various types of security and event management products that are configured to intelligently process the data to identify various events of interest. Such systems and the data they process are often referred to as SIEM (Security Information and Event Management) systems and data, and that term is employed herein for convenience, without limiting the scope of the discussion. For instance, many SIEM systems include a user interface in the form of a dashboard that allows troubleshooters and other entity personnel to view a display (e.g., list, map, etc.) of such identified events and take remedial action if necessary. Each graphically displayed event may include or allow the personnel to view various types of information including but not limited to a classification of the event (e.g., “compromise,” “denial of service,” etc.), normalized time stamps corresponding to when the event was first detected, a source of the data, etc. Personnel may also be able to drill down into the event on the dashboard to obtain more detailed information such as the original (e.g., pre-processed or raw) data, metadata about the same, and/or the like. These systems are continuously challenged to identify and classify emerging security or cyber threats.

In many cases, the STEM system monitoring a network (“client network”) could benefit from experience and information accumulated in connection with monitoring other networks. For example, a SIEM system monitoring a first client network may identify an emerging threat and develop information about that threat such as a source IP address, a geolocation for the source, a content of a suspicious message or series of messages, or a pattern of behavior indicative of an emerging threat. That information could be useful in developing rules or otherwise tuning the operation of the SIEM system monitoring other client networks. In addition, SIEM systems may ingest a large volume of system data (“data signal” or “signal”), for example, including log messages and other structured and unstructured data, from many hardware, firmware, and software components to monitor the client network. It is generally useful for the SIEM system to be able to identify and process such data. However, as components are added, replaced, and updated, the SIEM system may have difficulty in processing associated data or may require new information or rules to properly handle the data. It would be useful, where one client develops such information, to make the information available to other clients.

Unfortunately, there are a number of obstacles that limit the ability of SIEM systems to make use of such crowded-sourced information. First, there are, of course, security concerns regarding importing such information into a SIEM system. Clients would need to be certain that such information came from a trusted source. In addition, it is important that this information is verified before being incorporated into the SIEM system for a particular client. For example, the first client to develop rules or information concerning a new component, for example, a newly released or updated firewall product, may provide incomplete or inaccurate information that may not be helpful or could adversely impact the operation of a SIEM system. Finally, SIEM systems are often highly customized for a particular network and network environment and may include interdependent rules and logic. In some cases, it is necessary to ensure that new rules or information do not negatively impact existing models. For at least these reasons, sharing of information for SIEM systems across client networks has been limited.

SIEM systems can perform a number of related functions. These include searching signal information, executing signal analysis functions such as applying rules or other logic (e.g., machine learning processes) to identify events or conditions of interest, and generating reports, among others. For example, a client may wish to perform a search to determine who has access to the system, to determine what systems have been accessed by a particular user, or to determine whether and how often a particular series of events has occurred. A user can execute such a search by entering a free-form or structured query including relevant parameters such as attributes (e.g., data fields or attributes) and values (e.g., identifiers or ranges).

To develop or implement a signal analysis function, a user may enter information defining conditions or events of interest. For example, a user may define users of interest, systems of interest, date ranges, activities of interest, and logic defining combinations of actions or circumstances that define an event of interest. Such an event may trigger an alarm or be recorded for purposes of a report among other things. In many SIEM systems, a user can also define custom reports, for example, concerning traffic levels and types, summarizing what systems have been accessed by whom and for what purposes, or summarizing identified threats and resolutions. These reports may be customized to identify users, systems, activities, and the like that should be included in the report.

These functions have generally been viewed as separate functions performed by distinct systems. Thus, the user may access a first system for conducting a search of signal information, a second system for developing and executing a signal analysis or monitoring function, and a third system for generating reports. It would be useful if a user, for example, upon identifying useful information in a search or report, could efficiently translate that information into a signal analysis or monitoring function, e.g., a rule for identifying potential threats.

### SUMMARY

The present invention is directed to a system and associated functionality for monitoring client networks based on certain shared services. The shared services include community content, developed in connection with monitoring multiple client networks, and curated content developed by verifying and enhancing the community content. In addition, the shared services may involve information aggregated across networks and logic developed based on analysis of multiple networks. The curated content thus provides network monitoring information from a trusted source that leverages the reach and experience of the community. The invention also enables network parameters specified in connection with one monitoring function, such as searching signal information, to be used for other network monitoring functions such as developing signal analysis rules.

In accordance with one aspect of the present invention, a system and associated functionality (“utility”) is provided for use in network monitoring and information management. The utility involves providing a first platform for monitoring data signals from one or more first client networks to identify information interest relating to the first client networks and connecting the first platform to a repository of shared information obtained in connection with monitoring more than one second client networks. The second client networks may overlap or be independent of the first client networks. For example, the first client networks may be a subset of the second client networks, or the second client networks may be separate from the first client networks. The utility further involves operating the first platform to receive a first data signal from a first network of the first client networks; operating the first platform to access, from the repository, one or more first items of the shared information; and operating the first platform to conduct an analysis of the first data signal using the first items of shared information and to provide an output based on the analysis. In this manner, the first platform can provide an enhanced analysis of the first signal based on the shared information developed in connection with the second client networks.

In certain implementations, the first platform may be operative to identify events of interest based on the first data signal, for example, to identify potential security threats. The first data signal may be based on logs generated by components of the first network and/or other structured and unstructured data. The first platform may be disposed on the first network or may be separate from the first network and connected to the first network via a first network interface. In addition, the first network may preprocess data to generate the first data signal. For example, data from one or more data sources may be augmented, batched, compressed, and authenticated to generate the first data signal. Moreover, depending on the deployment, the repository may be disposed on a client network, the first platform, or a second platform such as a cloud-based platform. The first platform may include multiple processing platform instances for processing data signals from multiple first client networks and the second platform may communicate with each of the multiple processing platform instances. The repository may include a community content collection and a curated content collection. In this regard, the system may further be operative for performing a verification of items of interest from the community content collection and selectively promoting the items of information from the community content collection to curated content collection based on the verification.

The utility may further involve a preprocessing module on the first network for accessing signal sources and preprocessing data from the signal sources to provide the first data signal. Such preprocessing may involve enriching the data from the signal sources with additional information to enhance processing by the first platform. In addition, the utility may involve establishing a communications pathway from the first platform to the first network. The communications pathway can then be used to access enrichment sources of the first network.

In accordance with another aspect of the present invention, a utility is provided for integrating multiple functions in a network monitoring and information management system. The utility involves providing a network monitoring platform including an interface for receiving one or more data parameters concerning one or more network monitoring functions, an access system for accessing signal information based on one or more data signals of the first client networks, and a processing system for executing the data monitoring functions. The data monitoring functions are selected from a function set including searching the signal information to identify responsive information based on data parameters, executing rules for monitoring the signal information based on the data parameters, and generating reports concerning the signal information based on the data parameters. The utility further involves receiving, via the interface, a first set of one or more data parameters for one or more first data networks, using the first set of data parameters to perform a first data function of the function set with respect to the first client networks, and using the first set of data parameters to perform a second function, different than the first data function, of the data function set with respect to the first client networks. In this manner, for example, a user can enter a set of parameters for performing a search of the signal data and then use the same parameters to define a rule for processing a data signal.

### BRIEF DESCRIPTION OF THE DRAWINGS

For a more complete understanding of the present invention, and further advantages thereof, reference is now made to the following detailed description, taken in conjunction with the drawings, in which:

FIGS. 1A-1B illustrate a core architecture of a network monitoring system in accordance with the present invention;

FIGS. 2A-2F illustrate various deployments of the network monitoring system of FIGS. 1A-1B;

FIGS. 3A-3F illustrate network ingress and network egress details of the network monitoring system of FIGS. 1A-1B;

FIG. 4 illustrates an egress relay that may be used in the network monitoring system of FIGS. 1A-1B;

FIG. 5 illustrates a SIP instance that may be used in the network monitoring system of FIGS. 1A-1B;

FIG. 6 illustrates additional details of an ingestion pipeline that may be used in the SIP instance of FIG. 5; and

FIG. 7 illustrates a processing system that uses input parameters for multiple functions of a network monitoring system in accordance with the present invention.

### DETAILED DESCRIPTION

The present invention relates to a network monitoring system that implements a variety of shared services that aggregate knowledge acquired in connection with multiple client networks and securely leverage such knowledge in monitoring networks of individual clients or entities. The invention also relates to implementing data parameters or filters across multiple system functions, e.g., so that parameters first used to search signal data can subsequently be used to develop a rule for network monitoring and/or to generate a report. In the following description, the invention is set forth in the context of specific implementations for deployment in relation to single tenant, multiple-tenant, and isolated network environments. While these implementations and environments illustrate advantageous features of the invention, the invention is not limited to these implementations and environments. Accordingly, the following description should be understood as illustrative and not by way of limitation.

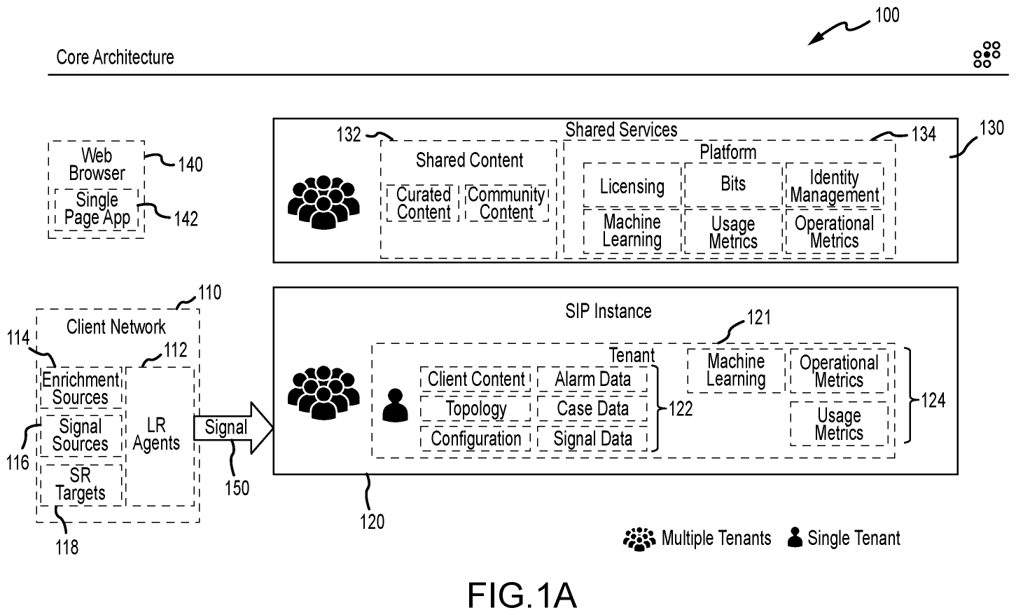

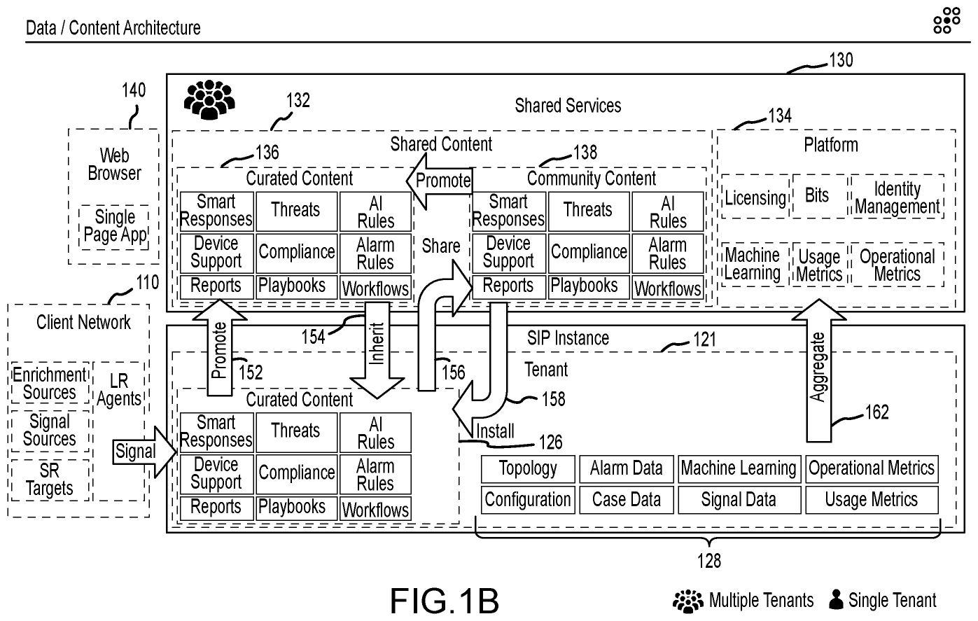

FIG. 1A is a schematic diagram depicting an architecture of a network monitoring system 100 in accordance with the present invention. The system 100 generally includes a client network 110, a security intelligence platform (SIP) 120, a shared services utility 130, and a browser platform 140 running an application 142. Generally, the client network 110 provides a data signal 150, for example, a stream of logs and other structured, unstructured, or hybrid (e.g., a structured data object with unstructured content portions) to the SIP 120 which monitors the client network 110 based on the signal 150 and provides dashboard network information, generates alarms, and provides reports and other processed data as outputs. As described below, such monitoring may leverage various shared services of platform 130. These platforms and associated functionality are described below.

In many of the figures, icons are provided to identify environmental attributes (e.g., single tenant or multi-tenant), network environment or supported systems (e.g., certain third-party cloud service environments), and managing entity (e.g., client or system operator). These icons are generally explained in a key provided at the bottom of the relevant figure.

The client network 110 is a network that is monitored by the SIP 120. The network may be, for example, a LAN, VPN, or any other network that is monitored as an entity and may be at a single facility/location or may be geographically distributed. The network 110 will generally include multiple hardware components, firmware components, and software components that function as signal sources 116. The illustrated network includes one or more agents 112, identified as agents provided by LogRhythm, Inc., the assignee of the present application, that collects logs and other data that are provided to the SIP 120 in raw or processed form as signal 150. The signal sources 116 provide the bulk of the data for the signal 150 and may include, for example, routers, switches, file servers, applications, and the like. The Smart Response (SR) Targets 118 comprises logic to automate certain responses in the client network environment. For example, a client network may have a rule that provides that, when a certain kind of activity is detected, an account may be automatically disabled, or an IP address may be blocked. The enrichment sources 114 provide certain information to supplement or annotate logs or other input information to enhance the value of the input information. For example, such enrichment may involve adding geolocation information for the log that may be correlated to threats from around the world or associating a true identification with the log where a single person or entity is associated with multiple identifications or addresses.

The SIP 120 may embody a number of SIP instances 121, each of which services one or more tenants, e.g., an entity that provides content to and receives services from the SIP 120. A tenant may be associated with one or more client networks 110. As shown, each SIP instance 121 may include tenant information 122 useful for understanding and processing the signal 150, and model information 124 for analyzing the signal 150. In the illustrated example, the tenant information 122 includes client content which provides a knowledge base of information concerning the client network 110; topology information which defines the organizational structure of the client and/or client network 110 including hierarchical relationships of entities; configuration information which describes configurations or possible configurations of elements of the client network 110 or combinations thereof; alarm data that defines various conditions, states, and thresholds that may trigger alarms based on rules developed by or for a client/network; case data which comprises information concerning events or patterns of behavior relevant to monitoring the client network 110 including threats that have previously been identified; and signal data which includes raw, processed, or aggregated data for the signal 150. All of this information, and other information, is useful to effectively monitor the client network 110.

The model information 124 includes various types of information developed in connection with monitoring the network 110 that collectively define a model of the network 110. The scanner 124 may include operational metrics, which are measurements and related data that define network attributes and performance, and usage metrics, which are measurements and related data that define usage levels and patterns for the client network 110 and its constituent components. The illustrated model information 124 also includes a machine learning model that evolves based on monitoring defined fields, attributes, values, and the like of the signal 150 and may be supervised, unsupervised, or some combination of supervised and unsupervised operation. Such machine learning and associated processing is generally described in U.S. Pat. No. 10,931,694 which is incorporated herein by reference.

The shared services utility 130 provides a variety of services that are shared among multiple clients of the system 100. For example, this may involve crowdsourcing solutions (e.g., if a certain client has developed information concerning a new application or component that is useful for network monitoring, the client may elect to share that information with the community of clients of the system 100), aggregating data across clients for improved anomaly identification or pattern recognition, and other sharing of information as between clients. The illustrated utility 130 includes shared content repository 132 and a shared services processing platform 134. For example, clients may share information about threats, AI rules, etc. with the community content collection of the shared content repository 132. That information may be verified, enriched, aggregated, or otherwise processed and then selected content may be promoted to the curated content collection. The curated content collection thus provides a rich collection of crowd-sourced and verified information, i.e., trusted information, for improved network monitoring.

The platform 134 is operative for executing a variety of functionality relating to the shared services utility 130. These may include verifying, enriching, and aggregating community information and promoting selected information from the community content collection to the curated content collection. As shown, this may include managing information concerning licensing related to accessing or sharing data; bits such as installation binaries or inputs from micro services that serve bitstreams; identity management information, e.g., log credentials and similar information; developing and implementing machine learning logic for processing shared information; and developing usage and operational metrics based on the shared data.

FIG. 1B depicts a data/content architecture of the system 100 of FIG. 1A and like items are identified by like reference numerals. As shown, a number of shared services are implemented in relation to the client content 126. The illustrated client content 126 may include information about smart responses, network threats, AI rules, device support, compliance (e.g., in relation to entity rules, government regulations, or the like), alarm rules, reports, playbooks (that defined responses or response options for a variety of events or situations), and workflows (defining sequences of processes for processing logs or signals). The additional elements 128 include various tenant information and model information as described above in connection with FIG. 1A.

As shown, the community content 138 and curated content 136 may include data elements corresponding to those of the client content 126. Information may be shared between the client content 126, community content 138, and curated content 136 in a number of ways. First, a client may choose to share (156) information from the client content 126 to the community content 138. For example, if a client network 110 includes a new signal source such as an app or hardware component that has not previously been supported by the system 100, rules may be developed by or for the client to recognize, attribute, enrich, and otherwise processed logs or other data. The client may choose to share this information and rules with the community content 138, e.g., to contribute to a richer and more quickly updated community threat detection environment that will ultimately benefit the sharing client as well as others in the community.

The system operator may then collect the information from the client, as well as related information from other clients, to verify and supplement such information. For example, the system operator may compile a set of attributes and rules, verify rules concerning the new signal source, and employ machine learning to continually develop a data model for the new data source, among other things. The resulting enhanced information concerning the new data source may then be promoted (160) to the curated content 136 that can be used to support multiple clients in the community. Specifically, such enhanced information may be inherited (154) by the sharing client and by other SIP instances supporting other clients.

In some cases, data elements may be promoted (152) directly from the client content 126 to the curated content 136. For example, this may occur when updates or corrections are required with respect to existing content. In addition, this may occur if there is an emerging threat or information about a new signal source that urgently needs to be included in the curated content 136 and/or with respect to certain categories of client content 136 for which verification or other processing is deemed unnecessary. In addition, in some cases information or logic from the community content 138 may be installed (158) into the client content 126, e.g., community information regarding network threats. Certain information from the additional elements 128, including at least the machine learning, operational metrics, and usage metrics, may be aggregated over time and/or across SIP instances, for example, to compile more complete metrics and provide an enriched dataset for machine learning. It is expected that a single SIP instance will not scale to support aggregation of this data across many clients.

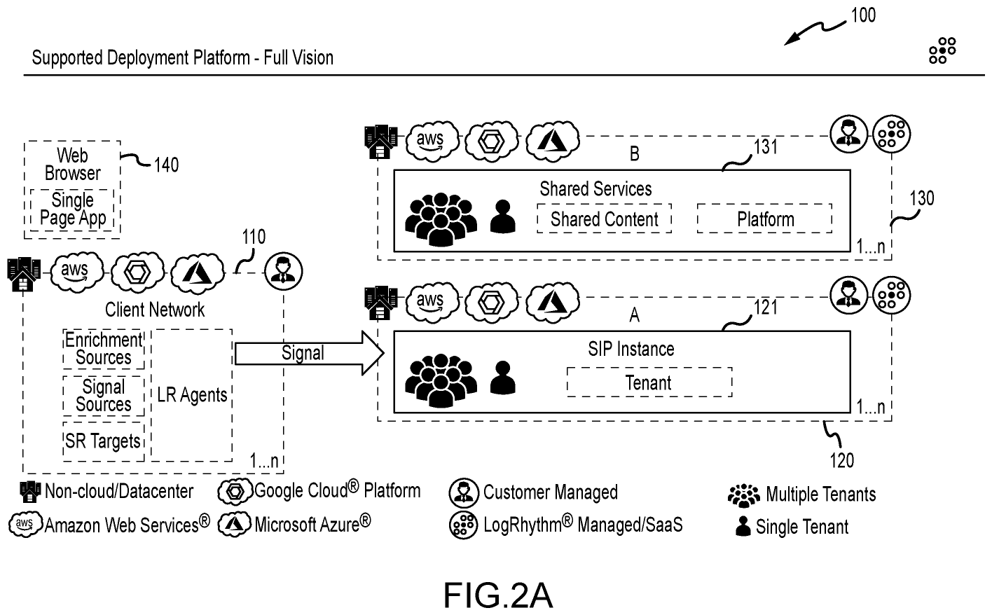

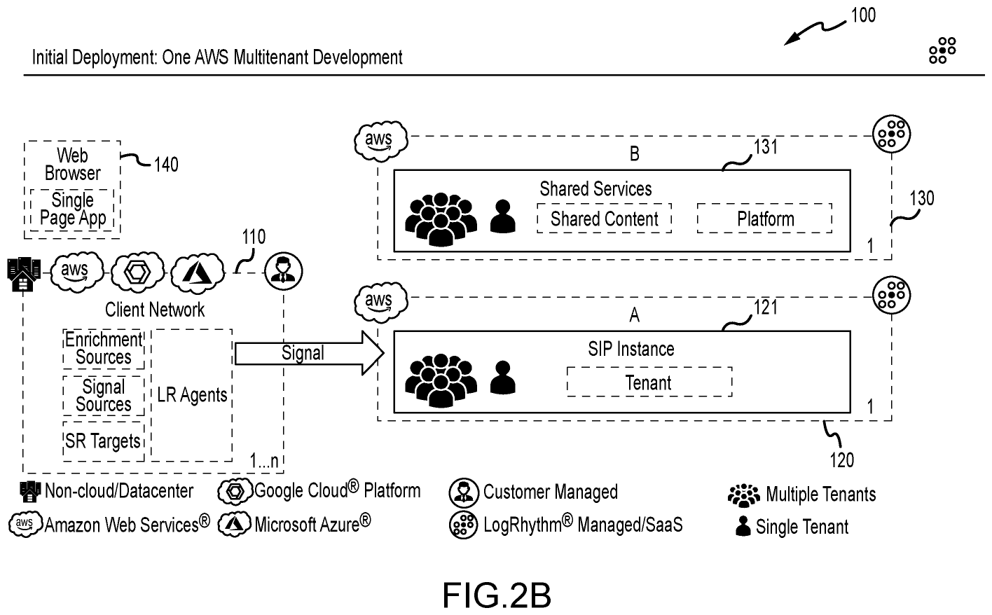

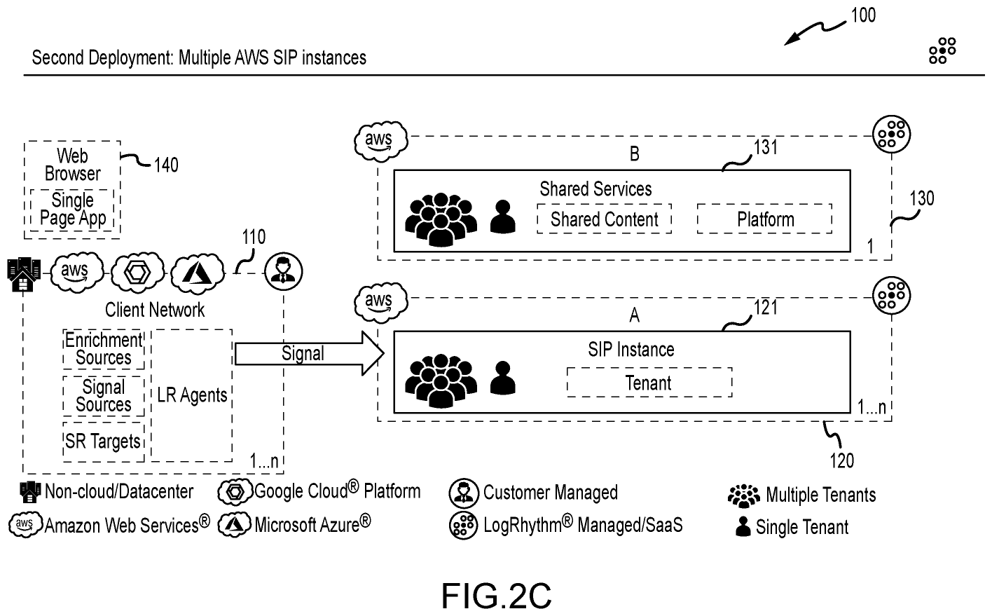

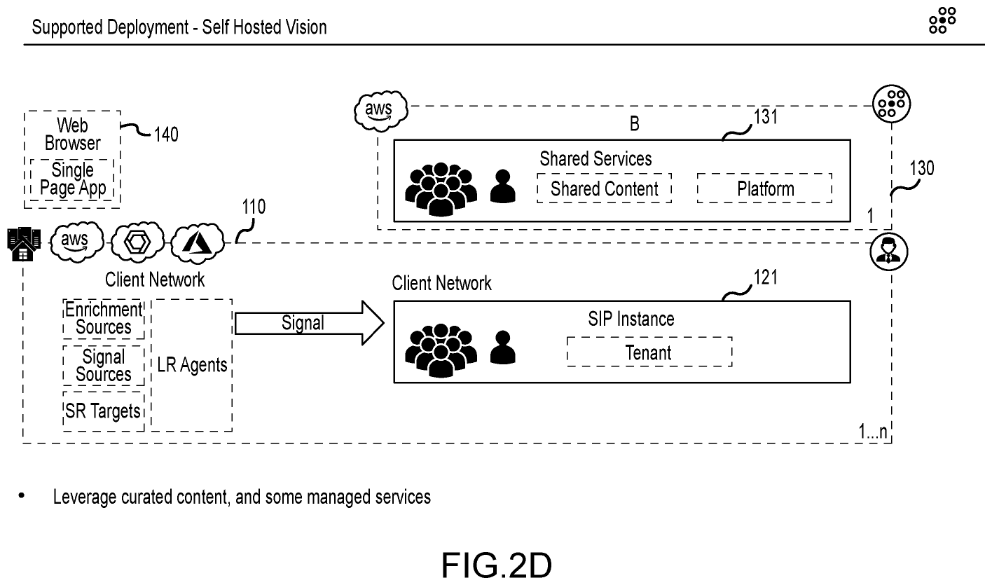

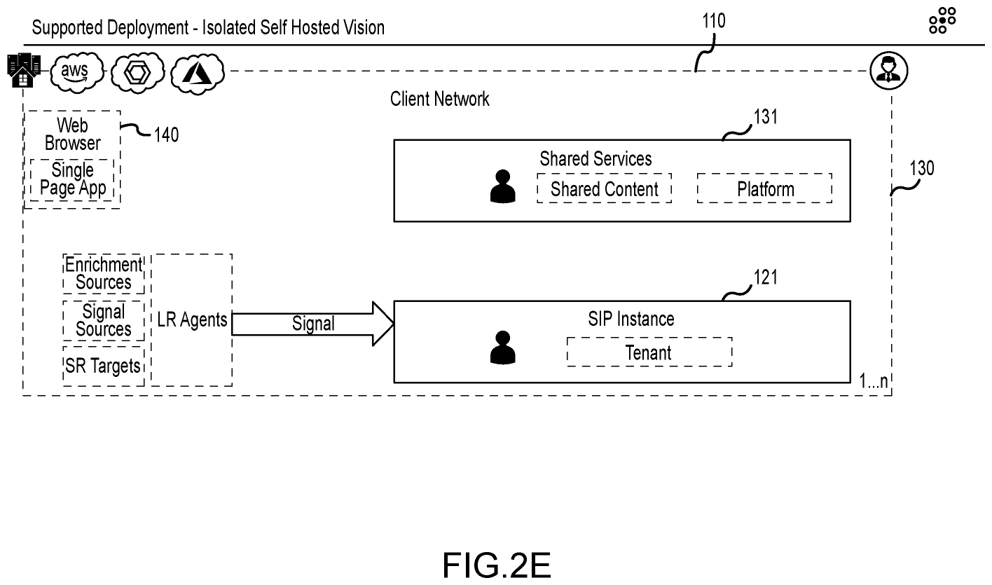

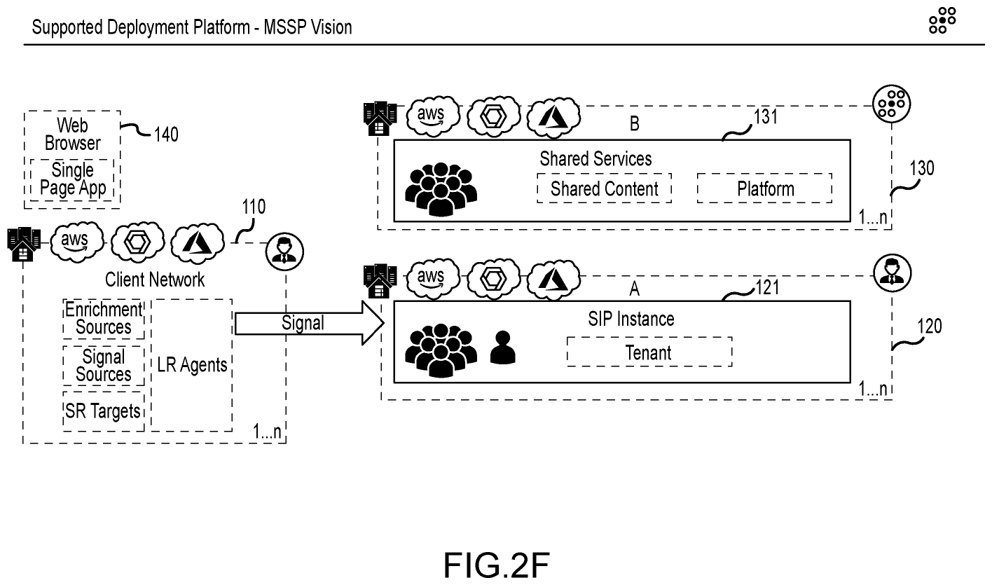

FIGS. 2A-2F illustrate various deployment environments and contexts for the system 100.

FIG. 2A shows a fully featured, general-purpose deployment and, in that sense, may be considered a full vision for the system 100. In this case, the SIP includes a number of client networks 110 (1 . . . n) and a number of SIP instances 121 (1 . . . n) that are associated with multiple instances of shared services 131 (1 . . . n) of a shared services utility 130. These components are not necessarily provided in a 1:1 relationship. For example, an SIP instance 121 may support multiple client networks or a single client network may be served by multiple SIP instances. In many cases, a shared services instance 131 may support multiple SIP instances 121. Moreover, the SIP instances 121 and shared service instances 131 can be single tenant or multitenant systems. This is scalable to support a large number of clients. It will be appreciated that hierarchies and protocols may be developed to enable sharing of information between SIP and shared services instances, e.g., to take advantage of knowledge base without copying data to an extent that inhibits scalability.

FIGS. 2A-2E include a number of icons to show how various platforms are physically/logically implemented (top left of each platform) and who owns or manages the relevant platform (top right). It will be appreciated that these are provided for purposes of providing a full understanding of exemplary implementations and not by way of limitation.

FIG. 2B shows a multitenant deployment in a single web services environment, in this case, Amazon Web Services®. That is, multiple client networks 110 (1 . . . n) are supported by a single SIP instance 121 of SIP 120 and a single shared services instance 131 of utility 130. For example, the deployment of FIG. 2B may be used in an initial stage of system deployment where only a single web service environment is implemented and multiple instances 121 and 131 are not required for scalability.

FIG. 2C shows a multiple SIP instance deployment. In this case, multiple client networks 110 (1 . . . n) are supported by multiple SIP instances 121 (1 . . . n) of SIP 120 and a single shared services instance 131 of utility 130. In this manner, multiple SIP instances 121 are provided for scale while the SIP instances 121 and networks 110 benefit from participating in a shared services ecosystem.

FIG. 2D shows a self-hosted deployment. Some clients may prefer to host a dedicated SIP instance, e.g., due to security, high customization, or other considerations. Such clients may still wish to leverage curated content and some managed services. Accordingly, in the illustrated deployment, a single SIP instance 121 is deployed on a client network 110. Multiple instances of such networks 110 (1 . . . n) may be supported by a single shared services instance 131 of utility 130. It will be appreciated that each client network instance 110 may have custom or selected rules governing sharing, installing, or inheriting content in relation to the shared services instance 131.

Some clients may prefer or require an isolated self-hosted deployment. For example, clients with heightened security requirements, such as defense contractors or critical infrastructure entities (nuclear power plants), may require isolated self-hosted deployments as shown in FIG. 2E. It will be appreciated that such clients may still need to address security threats even though they are not connected to the Internet. For example, such clients may be interested in badge detection and detecting suspicious behavior by employees. In this case, a single SIP instance 121, a single shared services instance 131, and the supporting web browser 140 are incorporated into the client network 110. Curated content may be included in the instance 131 and may be updated periodically, subject to security protocols.

FIG. 2F shows a Managed Security Service Provider (MSSP) deployment. In this case, like FIG. 2A, there are multiple client networks 110 supported by multiple SIP instances 121 and multiple shared services instances 131 (in various web services environments). However, in this case, the SIP 120 and utility 130 are managed by the client/tenant (or outsourced to an MSSP).

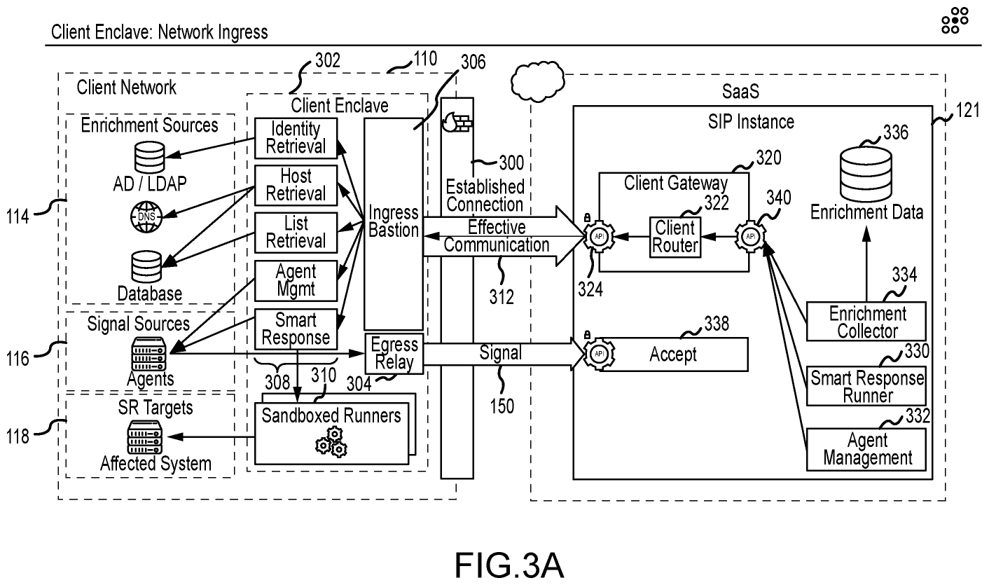

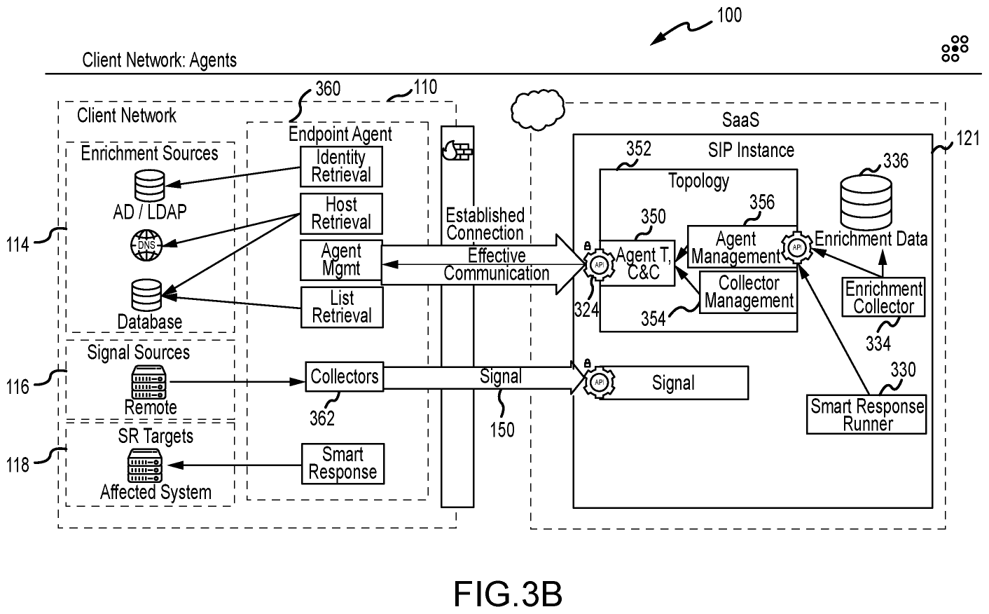

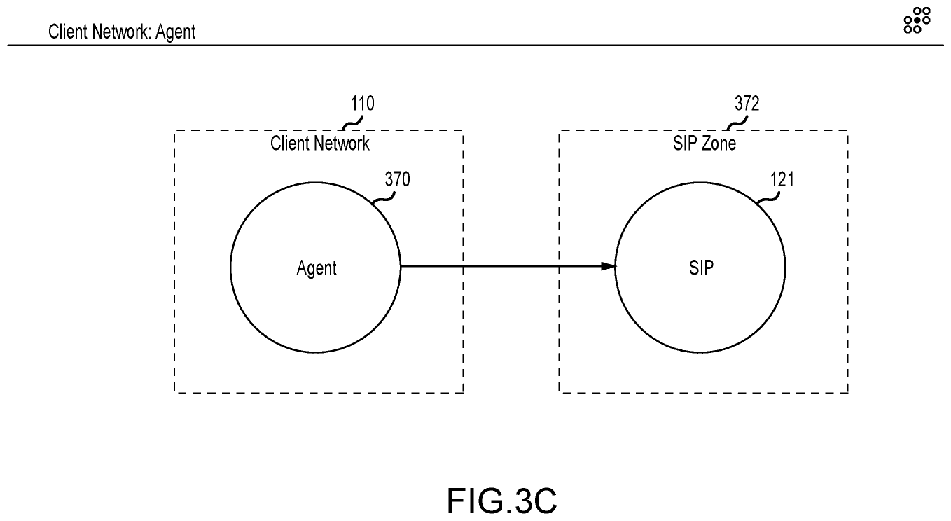

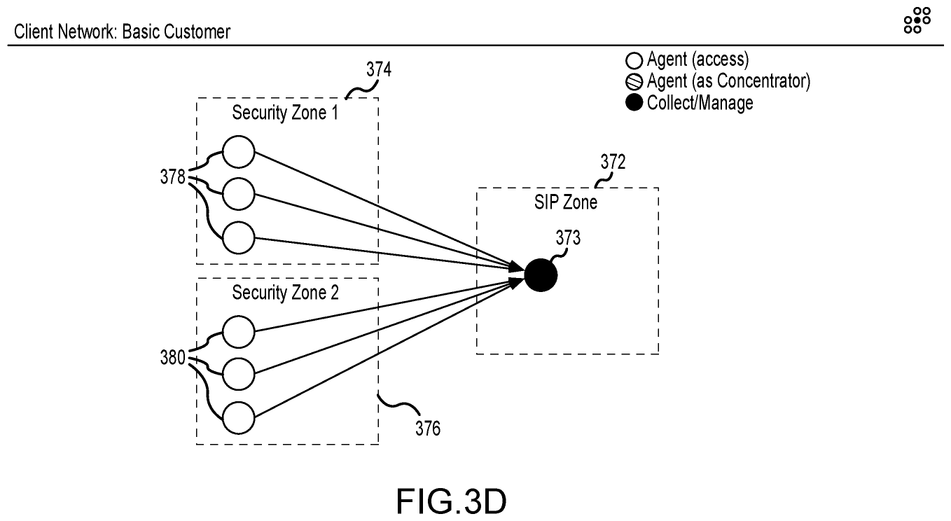

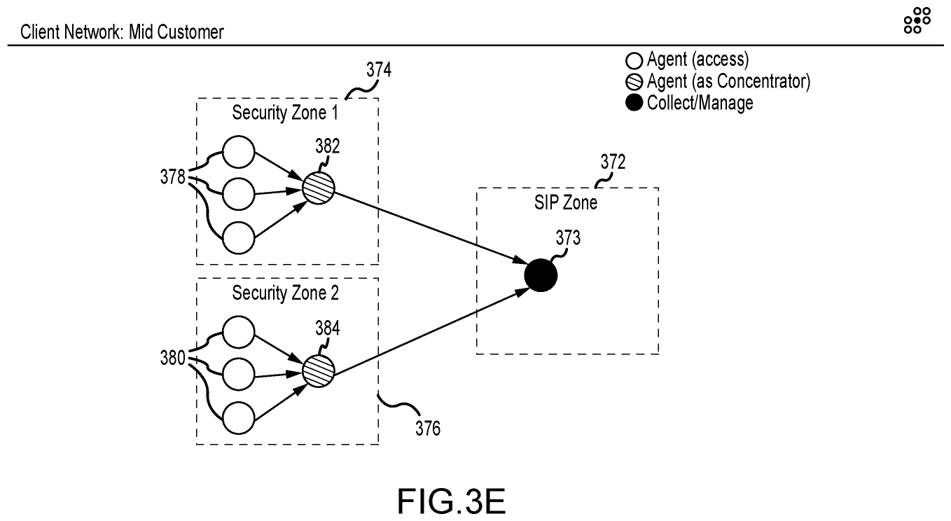

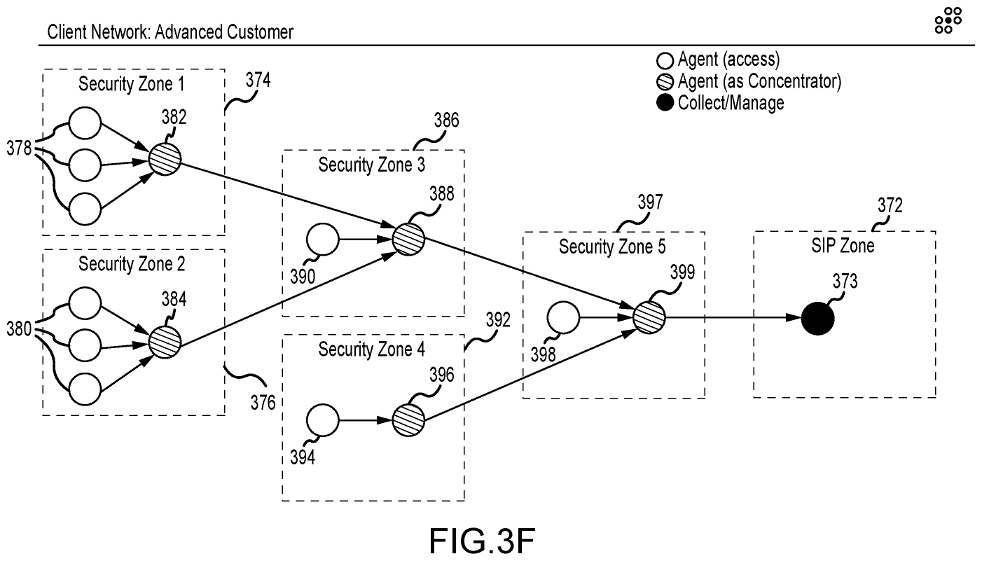

FIG. 3A shows additional details of one implementation for enabling communication between the client network 110 and an SIP instance 121. As discussed above, a large volume of data including the signal 150 is transmitted from the client network 110 to the SIP instance 121. However, it is also useful for the SIP instance 121 to be able to access the client network 110 to obtain data to assist in processing the signal 150, set appropriate alarms, and otherwise optimize monitoring functions. In order to allow such communication, the SIP instance 121 may need to penetrate a firewall 300. FIGS. 3A-3C illustrate various architectures that may be employed in this regard.

In the embodiment of FIG. 3A, the client network 110 includes a client enclave 302 for managing communications. The client enclave 302 may be embodied in hardware and/or software of the monitoring system 100 that is deployed on the client network 110 behind a firewall 300. The enclave 302 includes an egress relay 304 that transmits the raw or pre-processed signal 150 from the signal sources 116 to an accept module of the SIP interface 121, and an ingress bastion 306. In order to enable bidirectional communication, the client can open a communications pathway 312 between the ingress bastion 306 and a client router 322 of a client gateway 320 via API 324. The SIP instance 121 and then traverse that communications pathway 312 backwards to access the client network 110. In this regard, the bastion 306 performs multiplexing/demultiplexing operations to insert communications into the pathway 312 and extract communications therefrom.

Thus, the SIP instance 121 may communicate via the bastion 306 to access enrichment sources 114 to enrich data of the signal 150. The bastion 306 can then extract an associated request from the client gateway 320 and invoke one or more access functions 308 to access the enrichment sources 114. For example, in order to access the identity of users of the client network, the bastion 306 may invoke the identity retrieval function to access the active directory of sources 114. Similarly, to obtain host information, the bastion 306 may invoke the host retrieval function to access a DNS and/or system database of the sources 114. The bastion 306 may also access the database of enrichment sources 114 and the agents of the signal sources 116 by invoking the list retrieval and agent management functions.

As noted above, the system 100 may implement certain smart responses that are automated in response to defined conditions of the client network. For example, a rule may specify that when a certain kind of activity occurs, an account should be disabled, or a source IP address should be blocked. However, some clients may be unwilling to allow the system 100 full access to all client resources. Accordingly, sandbox runners 310 may be configured so that a client knows that such smart responses are limited to defined actions.

In the SIP instance 121, a smart response runner 330 may manage smart responses, e.g., by recognizing conditions that trigger an automated response, accessing an associated rule set, and directing the designated response. The agent management module 332 may work in conjunction with the corresponding component of the access functions 308 to manage agents of the signal sources 116 to collect signal information. The enrichment collector 334 works in cooperation with various access functions 308 to access the enrichment sources 114 to enrich signal data. The resulting information can then be stored in the enrichment data repository 336. Each of the components 330, 332, and 334 communicates with the client gateway 320 via an API 340. The SIP instance 121 further includes an accept module 338 for receiving and processing the signal 150 as will be described below.

FIG. 3B shows an alternative architecture for communications between the client network 110 and the SIP instance 121. In this case, a number of types of communications are conducted between an agent 350 of the SIP instance 121 and an agent 360 of the client network 110. The agent 350 is incorporated in a topology module 352 that also implements the collector management function 354 and an agent management function 356. The function 354 cooperates with collectors 362 of the agent 36o to collect the signal 150 from the sources 116. The other access functions as described above are also implemented by the endpoint agent 360. In addition, runner 330 and enrichment collector 334 generally function as described above but communicate with the topology module 352 instead of the client gateway 320 (FIG. 3A).

More generally, the client enclave 302 (FIG. 3A) can be reimagined as a single agent 370 of a client network 110 that communicates with an SIP instance 121 of multiple SIP instances in an SIP zone 372 as shown in FIG. 3C, or as a modular, hierarchical group of cooperatives agents, examples of which are shown in FIGS. 3D-3F. Referring to FIG. 3D, in a more basic case, a client may have more than one separately managed zones 374 and 376. Each of these zones 374 or 376 may have multiple agents 378 and 380, respectively, like the endpoint agent 360 described above (FIG. 3B), for accessing components of the client network. These agents 378 and 380 may communicate with a collector agent 373 of the SIP zone 372.

FIG. 3E shows a more complex arrangement that may be deployed in a larger client network. In this case, in each of the security zones 374 and 376, multiple access agents 378 and 380 communicate with a concentrator agent 382 and 384, respectively, which in turn communicates with a collector agent 373 of the SIP zone 372.

FIG. 3F shows a still more complex arrangement that may be deployed in a very large client network. In this case, a number of access agents 378, 380, 394, and 398 are distributed across multiple security zones 374, 376, 386, 392, and 397. The access agents 378, 380, 390, 394, and 398 communicate with concentrator agents 382, 384, 388, 396, and 399 which function as relay agents and communicate with other concentrator agents and, ultimately, collector agent 373. Other arrangements are possible, for example, where multiple concentrator agents communicate with the collector agent, where multiple collector agents are employed, where multiple concentrator agents are deployed in a single security zone, and where certain agents function as both an access agent and a concentrator agent, among others. It will be appreciated that such hierarchical arrangements provide great flexibility to scale to meet the needs of larger entities as well as entities with complex configurations of security zones.

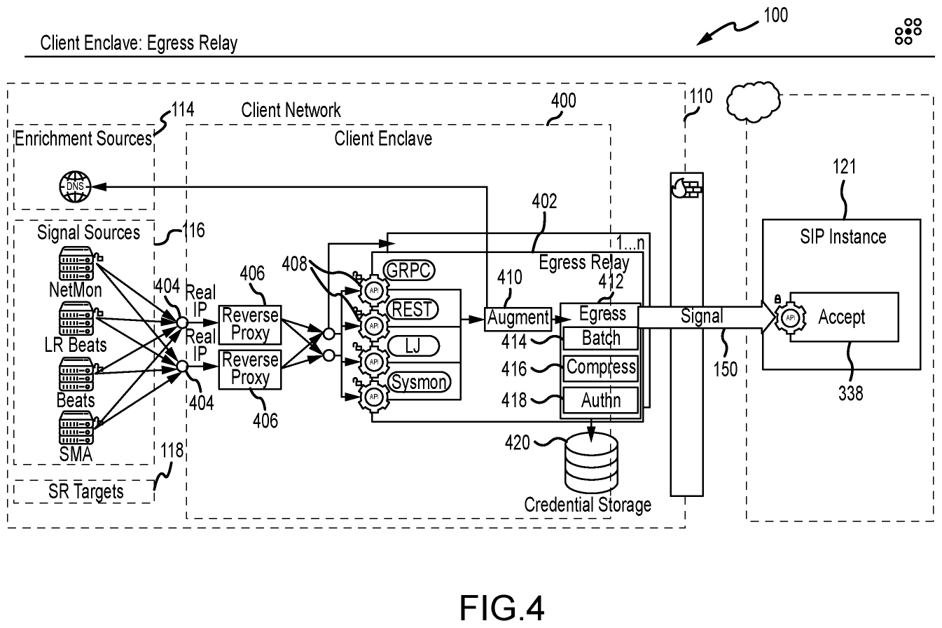

FIG. 4 shows details of an egress relay 402 used to collect data from the signal sources 116 and transmit the signal 150 to an SIP instance 121. As shown, multiple relays 402 (1 . . . n) may be implemented. Although the relay 402 is shown as being deployed in client enclave 400, the relay can be deployed in various agent architectures as described above. Signal data is transferred from the local agents (e.g., LogRhythm proprietary or other) of signal sources 116 to the egress relay 402 via one or more portals 404, one or more reverse proxies 406, and one or more APIs 408. Preferably, the system 100 includes at least two portals 404 (each communicating with all of the sources 116) associated with at least two reverse proxies 406 for redundancy. The illustrated relay 402 includes multiple APIs for natively supporting various protocols such as GRPC, REST, LumberJack, and Sysmon (LogRhythm proprietary).

The data from sources 116 may be augmented locally prior to transmission to the SIP instance 121. The illustrated relay 402 includes an augmented module 410 interposed between the proxies 406 and the egress module 412 and in communication with the enrichment sources 114. In this manner, data elements can be enriched with metadata, e.g., providing identification of users or systems as well as other topological information.

The augmented signal data is then processed by the egress module 412. Among other things, the module 412 may parse the data into processing batches (414), compress (416) the data for compact/timely transmission and authenticate (418) the data based on the stored credential information (420). The output from the relay 402 comprises the signal 150 that is transmitted to the SIP instance 121.

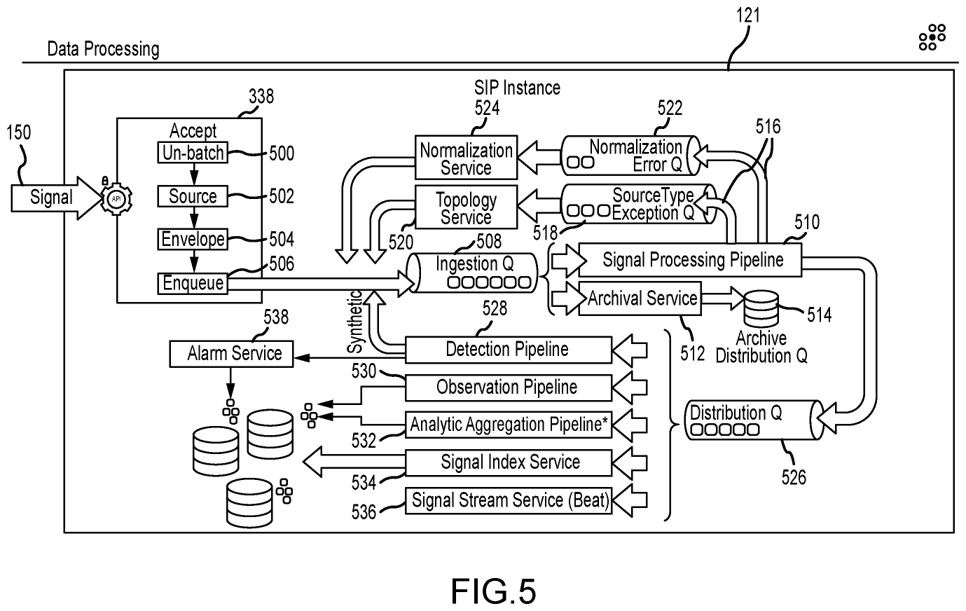

FIG. 5 shows details of the data processing components of an SIP instance 121. The signal 150 from the egress relay 402 (FIG. 4) is initially received by the accept module 338 via an API. The accept module 338 can perform a number of preprocessing functions such as un-batching (500) the signal 150, attributing the un-batched data elements with a source identification of the data (502) identifying where the data came from, and enveloping (504) and enqueuing (506) the data blocks for loading in the ingestion queue (Q) 508.

Data blocks extracted from the Q 508 are initially processed and a signal processing pipeline 510 that may verify and enrich the data blocks. Optionally, data from the Q 508 may also be processed by an archival service 512 for deposit in an archive 514. For example, archive data may be useful for longitudinal analysis, regulatory compliance, disaster recovery, and legal proceedings, e.g., discovery.

Among other things, the signal processing pipeline 510 may verify source types of the data and data types to ensure that the data is cognizable and suitable for further processing. Data that is not verified may be directed to feedback paths 516. Specifically, if the source type is not verified, the data may be loaded into SourceType Exception Q 518 and if the datatype is not verified, the data may be loaded into the Normalization Error Q 522. Data from the SourceType Exception Q 518 is processed by a topology service 520 to identify the appropriate data source type. For example, this may involve querying an enrichment source of the client network, for example, to identify new or updated hardware or systems. Additionally, or alternatively, data may be marked to be automatically accepted, the client may be asked to approve a source type or add the source type to the topology, or machine learning may be used to apply a source type and confidence score to the data. The data may then be attributed with metadata identifying the source type and fed back into the ingestion Q 508. Data from the Normalization Error Q 522 is processed by a normalization service 524 to normalize the data to a form appropriate for further processing. This may occur where the system 510 thought that it recognized the data but then tried to ingest the data and got an error. Processing by the service 524 may involve querying the client network and rewriting or reformatting data blocks. The resulting normalized data is fed back into the Ingestion Q 508.

Data that is validated, e.g., normalized and associated with a recognized source type, is transferred to Distribution Q 526 for distributing to processing elements 528, 530, 532, 534, and 536. In addition, any data that is not validated may be marked and passed to Q 526 unprocessed. The detection pipeline 528, observation pipeline 530, and analytics aggregation pipeline 532 perform advanced analytics, including artificial intelligence and machine learning, as described in US Pat. No. 10,931,694 referenced earlier. The observation pipeline 530 and detection pipeline 528 separate the ML/AI processing between learning (observation) and applying what has been learned to make decisions (detection). Thus, the observation pipeline is continually developing an AI model, in a supervised or unsupervised mode, based on observations concerning the data and feedback concerning events and other results.

The detection pipeline 528 performs a variety of functions including developing baselines, detecting anomalies in relation to baselines, characterizing anomalies, and the like. In some cases, an anomaly or series of anomalies may be elevated to an alarm that is provided to appropriate system/personnel in an appropriate form (e.g., indicating a priority status) by alarm service 558. In addition, processing by the pipeline 528 may develop a synthetic signal that is fed back into Ingestion Q 508 for reprocessing. For example, pipeline 528 may be able to process unprocessed data (e.g., parse into multiple blocks, attribute, and enrich data, etc.) so as to facilitate or improve processing. The analytics aggregation pipeline 532 may aggregate multiple analytics for enhanced anomaly detection and characterization.

The signal index service 534 takes the brunt of the signal load, i.e., this is where the bulk of the signal data goes and does not generate many alarms. Finally, the signal stream service 536 provides an enhanced signal stream that can be exported to other, external services. For example, a client may wish to access a processed, fully attributed, and enriched signal stream for use by legacy or other systems for performing additional analyses.

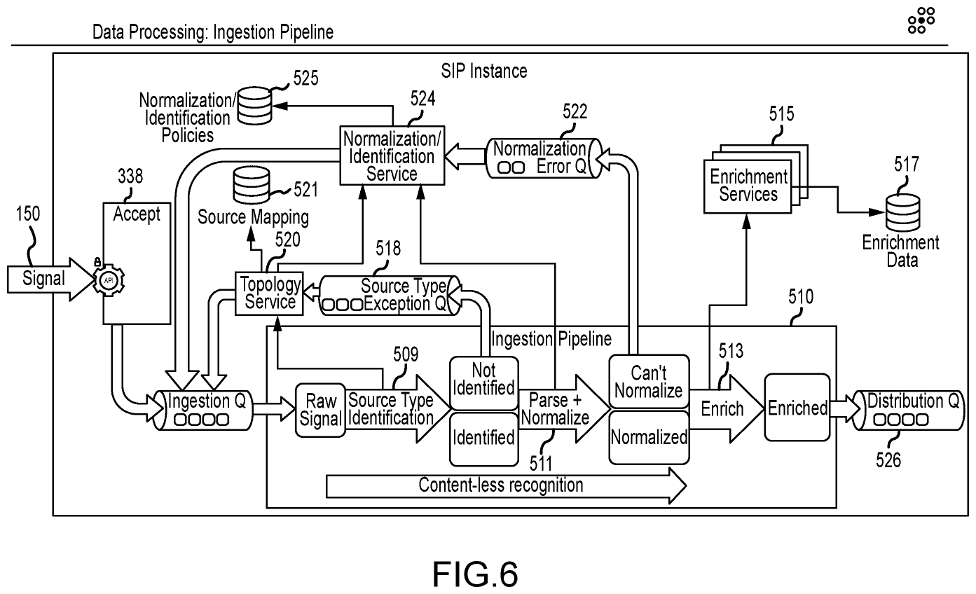

FIG. 6 shows additional detail related to the signal processing pipeline 510 or ingestion pipeline. The pipeline 510 may perform the functions of source type identification 509, parsing and normalizing data 511, and enriching data 513. The normalization service 524 may generate normalization or identification policies that are stored in database 525. The topology service 520 may generate source mapping information that is stored in database 521. The enrichment services 515 may generate enrichment data that is stored in database 517. The resulting data delivered to the Distribution Q 526 thus includes a source type attribution, is parsed, and normalized, and is enriched with a variety of metadata as discussed above.

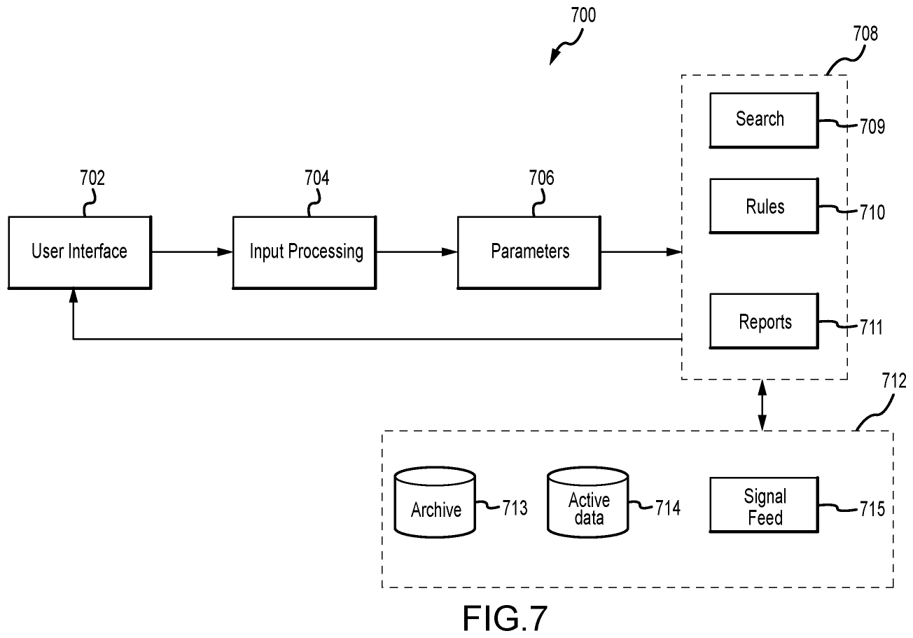

FIG. 7 is a block diagram illustrating a multi-function processing system 700 that may be implemented in connection with a network monitoring system in accordance with the present invention. The system 700 includes a user interface 702 that may be employed by a user to enter an input such as a query. The input may be entered as a free-form query or in a structured form, for example, by populating various predefined fields of a template. The resulting input is processed by input processing module 704 to extract parameters 706 of the input query. For example, such parameters may include attributes or data fields and associated values or ranges. The resulting parameters are provided to various functions of a processing module 708 such as a search function 709, a rules function 710, and a reports function 711. In this regard, the search function 709 may be used to search signal data 712 that may include archived signal data 713, active signal data 714, and substantially real time signal feed data 715. In this regard, the active data 714 may include signal data accumulated over a period of hours, days, weeks, months, or more that is used by a network monitoring system to identify events or patterns of behavior of interest. The archived data 713 may include data accumulated over a longer timeframe or otherwise designated for archiving. The signal feed 715 comprises the signal from one or more client networks that is transmitted to the network monitoring system. The rules module 710 can generate rules that can be applied by the network monitoring system to monitor a signal from signal sources of a client network. The reports module 711 generates reports based on the signal data 712.

The parameters 706 can be provided to each of the modules 709-711. Thus, for example, if the user inputs a search query identifying users, systems, and the like, the same parameters can be used to generate a rule such that, for example, an event may be identified or an alarm may be triggered based on detecting a signal that satisfies the parameters. Similarly, the same parameters generated for a search can be used to generate a report from the signal data 712.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art

1. A method for use in network monitoring and information management, comprising:
providing a first platform for monitoring data signals from one or more first client networks to identify information of interest relating to the first client networks;
connecting said first platform to a repository of shared information obtained in connection with monitoring more than one second client networks that overlap or are independent of said first client networks;
first operating said first platform to receive a first data signal from a first network of said first client networks;
second operating said first platform to access, from said repository one or more first items of said shared information; and
third operating said first platform to conduct an analysis of said first data signal using said first items of said shared information and to provide an analysis output based on said analysis.

2. The method of claim 1, wherein said first platform is operative for identifying events of interest based on said first data signal.

3. The method of claim 2, wherein said events of interest relate to potential security threats with respect to said first network.

4. The method of claim 1, wherein said first data signal is based on logs generated by components of said first network.

5. The method of claim 1, wherein said repository is disposed on a second platform, separate from said first platform and connected to said first platform via a second network interface.

6. The method of claim 5, wherein said first platform comprises multiple processing platform instances for processing data signals from multiple first client networks and said second platform is operative for communicating with each of said multiple processing platform instances.

7. The method of claim 1, wherein said repository includes a community content collection and a curated content collection.

8. The method of claim 7, further comprising performing a verification of items of information from said community content collection and selectively promoting said items of information from said community content collection to said curated content collection based on said verification.

9. The method of claim 1, further comprising providing a preprocessing module on said first network for accessing signal sources and preprocessing data from said signal sources to provide said first data signal.

10. The method of claim 9, wherein said preprocessing comprises enriching said data from said signal sources with additional information to enhance processing by said first processing platform.

11. The method of claim 5, further comprising establishing a communications pathway from said first form to said first network.

12. The method of claim 11, further comprising using said communications pathway to access enrichment sources of said first network.

13. A system for use in network monitoring and information management, comprising:
a first platform operative for:
monitoring data signals from one or more first client networks to identify information of interest relating to the first client networks;
accessing a repository of shared information obtained in connection with monitoring more than one second client networks that overlap or are independent of said first client networks;
receiving a first data signal from a first network of said first client networks via a first network interface between said first network and said first platform;
obtaining from said repository one or more first items of said shared information; and
conducting an analysis of said first data signal using said first items of said shared information and providing an analysis output based on said analysis.

14. The system of claim 13, wherein said first platform is operative for identifying events of interest based on said first data signal.

15. The system of claim 14, wherein said events of interest relate to potential security threats with respect to said first network.

16. The system of claim 13, wherein said first data signal is based on logs generated by components of said first network.

17. The system of claim 13, wherein said repository is disposed on a second platform, separate from said first platform and connected to said first platform via a second network interface.

18. The system of claim 17, wherein said first platform comprises multiple processing platform instances for processing data signals from multiple first client networks and said second platform is operative for communicating with each of said multiple processing platform instances.

19. The system of claim 13, wherein said repository includes a community content collection and a curated content collection.

20. The system of claim 19, wherein said second platform is operative for performing a verification of items of information from said community content collection and selectively promoting said items of information from said community content collection to said curated content collection based on said verification.

21. The system of claim 13, further comprising providing a preprocessing module on said first network for accessing signal sources and preprocessing data from said signal sources to provide said first data signal.

22. The system of claim 21, wherein said preprocessing comprises enriching said data from said signal sources with additional information to enhance processing by said first processing platform.

23. The system of claim 17, further comprising a communications pathway from said first platform to said first network.

24. The system of claim 23, wherein said first platform is operative for using said communications pathway to access enrichment sources of said first network.

25. A method for use in network monitoring and information management, comprising:
providing a network monitoring platform including an interface for receiving one or more data parameters concerning one or more network monitoring functions, an access system for accessing signal information based one or more data signals of said first client networks, and a processing system for executing said data monitoring functions, said data monitoring functions selected from a function set of data functions for processing said signal information using said data parameters, said function set comprising the data functions of searching said signal information to identify responsive information based on said data parameters, executing rules for monitoring said signal information based on said data parameters, and generating reports concerning said signal information based on said data parameters;
receiving, via said interface, a first set of one or more data parameters for one or more first data networks;
first using said first set of said one or more data parameters to perform a first data function of said function set with respect to said first client networks; and
second using said first set of said one or more data parameters to perform a second data function, different than said first data function, with respect to said first client networks.

26. The method as set forth in claim 25, wherein said first data function comprises searching said signal information.

27. The method as set forth in claim 26, wherein said second data function comprises executing rules for monitoring said signal information.

28. The method as set forth in claim 25, wherein said signal information comprises one or more of archived signal data, active signal data, and a substantially real time signal feed.

29. A system for use in network monitoring and information management, comprising:
a network monitoring platform including an interface for receiving one or more data parameters concerning one or more network monitoring functions, an access system for accessing signal information based one or more data signals of said first client networks, and a processing system for executing said data monitoring functions, said data monitoring functions selected from a function set of data functions for processing said signal information using said data parameters, said function set comprising the data functions of searching said signal information to identify responsive information based on said data parameters, executing rules for monitoring said signal information based on said data parameters, and generating reports concerning said signal information based on said data parameters;
said network monitoring platform being operative for:
receiving, via said interface, a first set of one or more data parameters for one or more first data networks;
first using said first set of said one or more data parameters to perform a first data function of said function set with respect to said first client networks; and
second using said first set of said one or more data parameters to perform a second data function, different than said first data function, with respect to said first client networks.

30. The system as set forth in claim 29, wherein said first data function comprises searching said signal information.

31. The system as set forth in claim 30, wherein said second data function comprises executing rules for monitoring said signal information.

32. The system as set forth in claim 29, wherein said signal information comprises one or more of archived signal data, active signal data, and a substantially real time signal feed.
